(19) United States
(12) Patent Application Publication
(10) Pub. No.: US 2013/0054831 A1
(43) Pub. Date: Feb. 28, 2013

(54) REDIRECTING FILE TRAFFIC FROM A CORE SERVER TO THE NETWORK EDGE

(71) Applicants: Seraphin B. Calo, Cortlandt Manor, NY (US); Maroun Touma, Redding, CT (US); Dinesh C. Verma, New Castle, NY (US)

(72) Inventors: Seraphin B. Calo, Cortlandt Manor, NY (US); Maroun Touma, Redding, CT (US); Dinesh C. Verma, New Castle, NY (US)

(73) Assignee: INTERNATIONAL BUSINESS MACHINES CORPORATION, Armonk, NY (US)

(21) Appl. No.: 13/221,333

(22) Filed: Aug. 30, 2011

(51) Int. Cl. G06F 15/173

(52) U.S. Cl. 709/238

(57) ABSTRACT

File traffic redirection from a core server to a network edge. A request for a file from a target system is received from one or more requestors in direct communication with the computer. The request includes a host name of the target system. If the host name is not locally resolvable, requesting a resolution of the host name from a domain name resolution process external to the computer. An Internet protocol address of the target system is received from the domain name resolution process, and all subsequent file requests by any of the one or more requestors for files from the target system are routed directly to the target system without accessing a core network.

### BACKGROUND

This invention relates generally to processing within a computing environment, and more particularly to redirecting file traffic from a core server to the network edge.

With the great increase in data traffic due to the proliferation of computing devices and smartphones communications carriers have a shortage of bandwidth in their backhaul or core networks. Peer-to-Peer (P2P) networks for exchanging files between distributed users can generate large amounts of traffic, especially as their use on mobile devices increases. By redirecting file requests in P2P networks from the core wireless network to the edge of the carrier network, bandwidth requirements on the core portion of the network are decreased.

P2P network protocols have two stages. The first deals with finding the desired information, and the second deals with the transmission of that information to the requesting party. Since files, particularly media files, can be quite large, the second stage typically consumes more bandwidth than the first. When a file is located and the requesting device sends a message (e.g., HTTP GET) to the device that has a copy of the file (the target device), the address of the target device needs to be resolved by a DNS server in the core network. Once the address of the target system is resolved to an Internet protocol (IP) address, the request is routed over the core network to the second device, and the file transfer is initiated over the core network. The file transfer directly impacts the traffic over the core network even if the target system is sharing the same edge network equipment as the requestor.

### BRIEF SUMMARY

An embodiment includes method for redirecting file traffic from a core server to a network edge. The method includes receiving a request for a file from a target system from one or more requestors in direct communication with the computer. The request includes a host name of the target system. The method further includes determining if the host name is locally resolvable. If the host name is not locally resolvable, the method includes requesting a resolution of the host name from a domain name resolution process external to the computer. The method further includes receiving an Internet protocol (IP) address of the target system from the domain name resolution process, and routing all subsequent file requests by any of the one or more requestors for files from the target system directly to the target system without accessing a core network.

An additional embodiment includes a system for redirecting file traffic from a core server to a network edge, the system includes an edge proxy computer configured to perform a method. The method includes receiving a request for a file from a target system from one or more requestors in direct communication with the computer. The request includes a host name of the target system. The method further includes determining if the host name is locally resolvable. If the host name is not locally resolvable, the method includes requesting a resolution of the host name from a domain name resolution process external to the computer. The method further includes receiving an Internet protocol (IP) address of the target system from the domain name resolution process, and routing all subsequent file requests by any of the one or more requestors for files from the target system directly to the target system without accessing a core network.

A further embodiment includes a computer program product for redirecting file traffic from a core server to a network edge, the computer program product includes a tangible storage medium readable by a processing circuit and storing instructions for execution by the processing circuit for performing a method. The method includes receiving a request for a file from a target system from one or more requestors in direct communication with the computer. The request includes a host name of the target system. The method further includes determining if the host name is locally resolvable. If the host name is not locally resolvable, the method includes requesting a resolution of the host name from a domain name resolution process external to the computer. The method further includes receiving an Internet protocol (IP) address of the target system from the domain name resolution process, and routing all subsequent file requests by any of the one or more requestors for files from the target system directly to the target system without accessing a core network.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a schematic diagram of a system for redirecting file traffic from a core server to the network edge that may be implemented by an embodiment;

FIG. 2 depicts a schematic diagram of a system for redirecting file traffic from a core server to the network edge;

FIG. 3 depicts a schematic diagram of a multi-zone radio access network in an embodiment;

FIG. 4 depicts a schematic diagram of a multi-zone radio access network with transitioning client handsets in an embodiment;

FIG. 5 depicts a flow diagram of the processing of a request for a file transfer from one client handset to a second client handset in an embodiment; and

FIG. 6 depicts a flow diagram of the handling of the transfer of a client handset from a first zone to a second zone in an embodiment.

### DETAILED DESCRIPTION

An embodiment of the present invention provides for redirecting file traffic from a core server to the network edge.

In an embodiment, an edge proxy on a network, such as a wireless carrier network, maintains a local directory of devices that are connected to the edge device. When file requests are received the IP address of the target host of the file request is resolved at the core network, and if the target host is also attached to the edge proxy the request is routed by the edge proxy directly to the target host therefore bypassing the core network. The address resolution information of the target host is also stored at the edge proxy so that any subsequent access requests to the same target host from other devices connected to the same edge proxy are automatically redirected to the target host. This eliminates any network traffic used to support the request that is sent to the core network and thereby reduces the load on the core network.

In an embodiment, as the mobile device moves between zones, the resolution information is passed to the edge proxy of the new zone and removed from the current zone. Therefore, all requests received by the new zone for files on the mobile device will be locally resolvable without requiring the use of the core network.

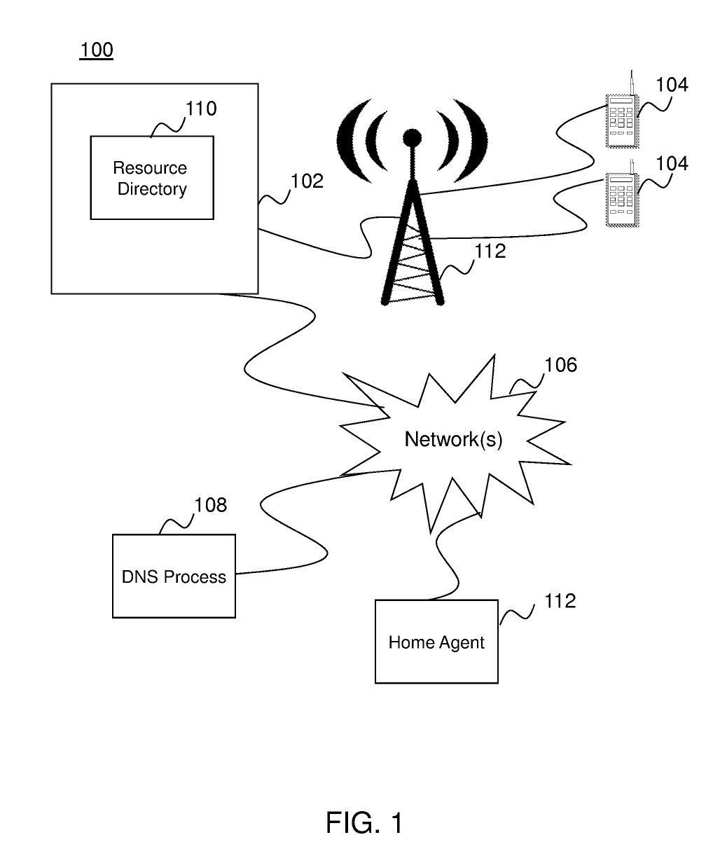

Turning now to FIG. 1, a system 100 for redirecting file traffic from a core server to the network edge. In an embodiment, the system 100 includes a host system computer 102 executing computer instructions for redirecting file traffic from a core server to the network edge. The host system computer 102 may operate in any type of environment that is capable of executing a software application. The host system computer 102 may comprise a high-speed computer-processing device, such as a mainframe computer, to manage the volume of operations governed by an entity for which the system for redirecting file traffic from a core server to the network edge is executing. In an embodiment, the host system computer 102 is part of an enterprise (e.g., a commercial business) that implements the system for redirecting file traffic from a core server to the network edge. In an additional embodiment, the host system computer 102 is a hardware or software component executing directly at a radio access network, such as the radio access network 112. In an embodiment, the host system computer 102 operates as an edge proxy server.

In an embodiment, the system 100 depicted in FIG. 1 includes one or more client handsets 104 through which users at one or more geographic locations may contact the host system computer 102 or each other. The one or more client handsets 104 are coupled to the host system computer 102 through a radio access network 112. In an embodiment, the edge proxy server is executed directly on the radio access network 112. Each of the one or more client handsets 104 may be implemented using a general-purpose computer executing a computer program for carrying out the processes described herein such as a mobile phone or a smart phone. In an embodiment, the one or more client handsets 104 are capable of Internet connectivity, and are capable of the execution of software thereon. The one or more client handsets 104 connect to the radio access network 112. In an embodiment, the one or more client handsets 104 are mobile telephone handsets, and in an embodiment, the one or more client handsets 104 move between one or more radio access networks 112 as is known in the art.

In an embodiment, the host system computer 102 is an edge proxy server in communication with the radio access network 112. In an embodiment, the host system computer 102 executes on or within the radio access network 112. In an embodiment the host system computer 102 includes a P2P resource directory 110. The P2P resource directory 110 includes a description of the client handsets 104 associated with the edge proxy 102. The description includes the IP address of the handset 104 but and may also be extended to include other information such as, the P2P protocols that each handset 104 supports, reserved bandwidth for P2P traffic security requirements, access control, etc. In an embodiment, the resource directory 110 is a hardware device included in the host system computer 102. In an additional embodiment, the resource directory 110 is a hardware device included in the radio access network 112. In yet another embodiment, the resource directory 110 is software executing on the host system computer 102/and or the radio access network 112. In an embodiment, the host system computer 102 is in communication to one or more networks 106. The one or more networks 106 may be any type of known network including, but not limited to, a wide area network (WAN), a local area network (LAN), a global network (e.g., Internet), a virtual private network (VPN), and an intranet. The networks 106 may be implemented using a wireless network or any kind of physical network implementation known in the art.

The host system computer 102 is communication with a DNS resolution process 108 such as a DNS server or other methods and systems for domain name resolution as is known in the art. The DNS resolution process 108 provides domain name resolution for the host system computer 102, and the client handsets 104. In an embodiment the DNS resolution process 108 is in communication with other domain servers and agents on the network to assist in domain name resolution, as is known in the art. In an embodiment, the DNS resolution process is coupled with other mobility standards, such a Mobile IP, in order to define for each handset 104 a home IP address and a care-of IP address. The home IP address provides the address of the home agent 112 while the home agent 112 maintains the care-of IP address of the handset 104. As previously described, it is understood that separate servers may be utilized to implement the network server functions and the application server functions. Alternatively, the network server, the firewall, and the application server may be implemented by a single server executing computer programs to perform the requisite functions.

It will be understood that the redirecting of file traffic from a core server to the network edge system described in FIG. 1 may be implemented in hardware, software executing on a general-purpose computer, or a combination thereof.

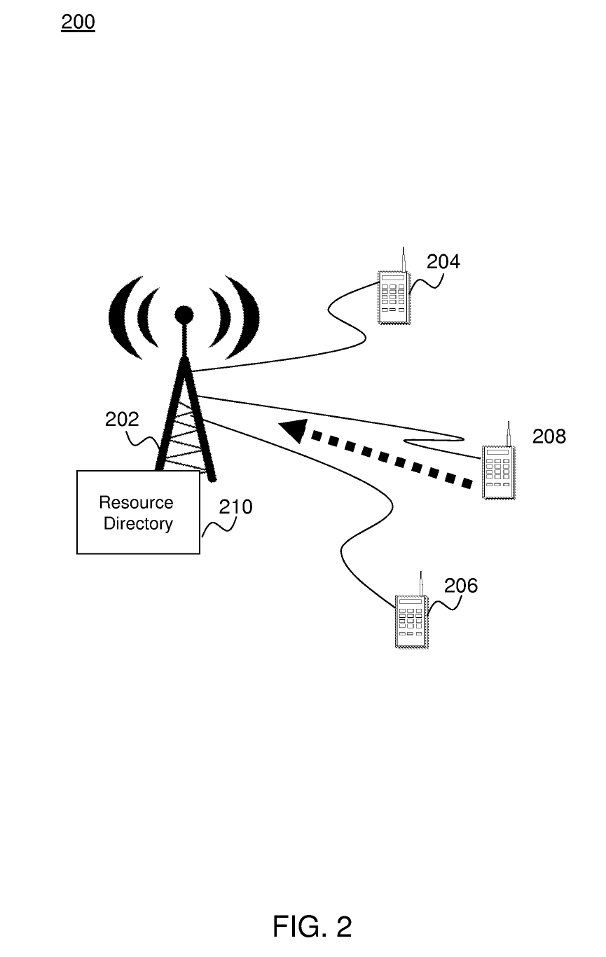

FIG. 2 depicts a schematic diagram of a system 200 for redirecting file traffic from a core server to the network edge. In an embodiment, the system 200 includes a radio access network 202. The radio access network 202 includes a resource directory 210 and one or more client handsets 204, 206, and 208. The radio access network 202 includes a radio tower, communication equipment and network equipment as is known in the art. The radio access network 202 allows each of a plurality of handsets to communicate both telephonically and over a network. In an embodiment, the radio access network 202 enables the client handsets 204, 208 and 206 to communicate over a core network, such as the Internet. The radio access network 202 supports communication for a set of client handsets 204, 206, and 208 in a particular geographic area called a zone. As client handsets, such as client handset 208 enter the radio access network's 202 zone, the client handset is seamlessly passed to the radio access network 202 from a separate zone. In an embodiment, each of the client handsets 204, 206 and 208, are connected to the radio access network 202 and are therefore part of the radio access network's zone. In an embodiment, each of the client handsets 204, 206 and 208 execute file-sharing software, such as peer-to-peer (P2P) software. In an embodiment, the client handset 208 executes the P2P software and initiates a file transfer request. The file transfer request is routed to the radio access network 202 and is served by the target of the request through the attached network. In an embodiment, the radio access network 202 includes a resource directory 210.

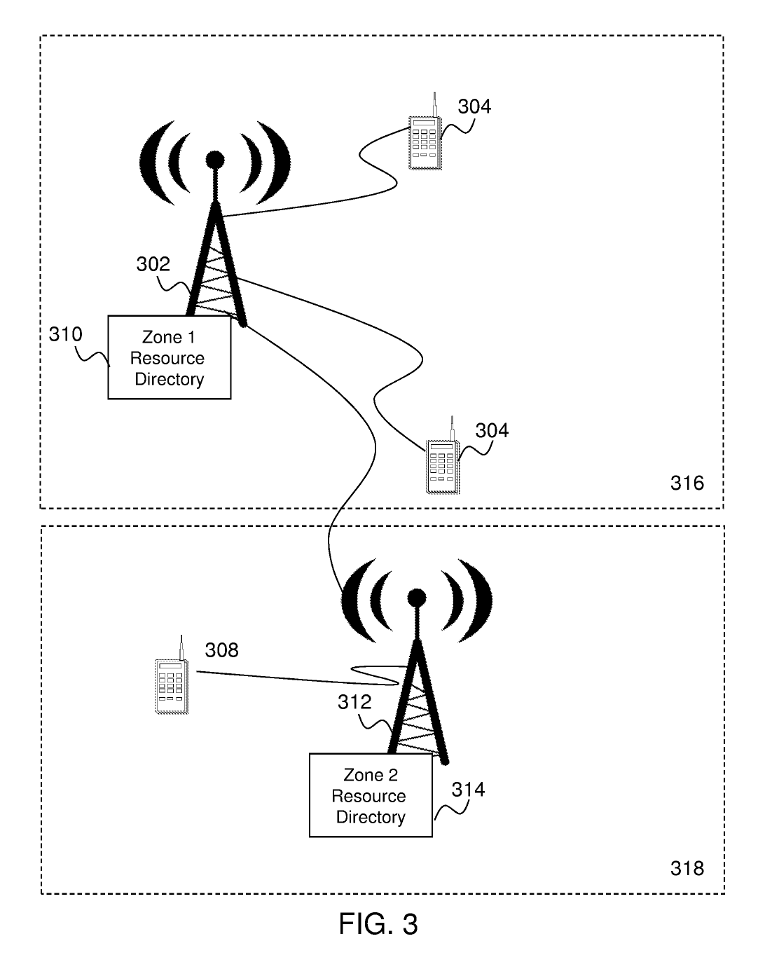

FIG. 3 depicts a schematic diagram of a multi-zone radio access network in an embodiment. In an embodiment, the multi-zone radio access network includes zone one 316. Zone 1 316 includes a zone 1 radio access network 302. The zone 1 radio access network 302 includes a zone 1 resource directory 310. The zone 1 resource directory 310 includes DNS resolution information for one or more zone 1 client handsets 304. The zone 1 radio access network 302 is in communication with a zone 2 radio access network 312. The zone 2 radio access network 312 is within zone 2 318. The zone 2 radio access network 312 includes a zone 2 resource directory 314. The zone 2 resource directory 314 includes DNS resolution information for one or more zone 2 client handsets 304. In an embodiment, zone 1 316 and zone 2 318 occupy different geographical areas. In an additional embodiment, the zone 1 316 and zone 2 318 occupy overlapping geographic regions. Each of the one or more client handsets 304 and 308 may move between either of the zones and are transferred to the radio access network within the new zone as will be described in more detail below.

FIG. 3 depicts a limited number of radio access networks and handsets for purposes of clarity. It will be understood that in additional embodiments any number of zones, radio access networks, and client handsets may be supported.

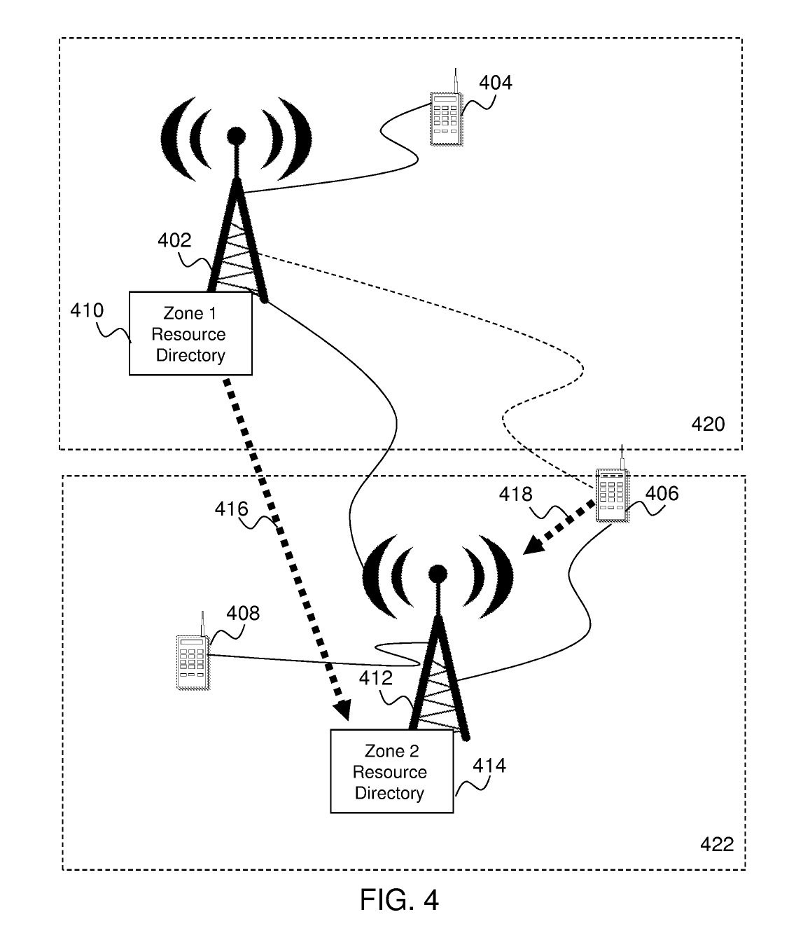

FIG. 4 depicts a schematic diagram of a multi-zone radio access network with transitioning client handsets in an embodiment. In an embodiment, the multi-zone radio access network of FIG. 4 includes a zone 1 420 and a zone 2 422. The zone 1 420 includes a zone 1 radio access network 402. The zone 1 radio access network 402 includes a zone 1 resource directory 410 as described above. The zone 2 422 includes a radio access network 412. The radio access network 412 includes a zone 2 resource directory 414. The zone 1 radio access network 402 is in communication with the zone 2 radio access network 412. In an embodiment the zone 1 radio access network 402 is in communication with a first client handset 404 and a second client handset 406. In an embodiment the zone 2 radio access network 412 is in communication with a third client handset 408. In an embodiment, each of the zone 1 radio access network 402 and the zone 2 radio access network 412 include resolution information for each of the client handsets that they are in communication with.

In an embodiment, the second client handset 406 transitions from the zone 1 420 to the zone 2 422. As the second client enters the zone 2 422, it makes a handshake 418 with the zone 2 radio access network 412 and is seamlessly passed from the zone 1 radio access network 402 to the zone 2 radio access network 412. In an embodiment, as the second client handset 406 is passed the zone 2 radio access network 412, the resolution information that was stored in the zone 1 resource directory 410 is transferred to the zone 2 resource directory 414 using a transfer operation 416. In an embodiment, from that point forward, any file requests from the third client handset 408 to the second client handset 406 are resolved locally at the zone 2 radio access network 412 and directed to the second client handset 406 directly without requiring access to the core network (not shown). In an embodiment, zone 1 420 and zone 2 422 occupy different geographical areas. In an additional embodiment, the zone 1 420 and zone 2 422 occupy overlapping geographic regions. Each of the one or more client handsets 404, 406 and 408 may move between either of the zones and are transferred to the radio access network with the new zone as will be described in more detail below.

FIG. 4 depicts a limited number of radio access networks and handsets for purposes of clarity. It will be understood that in additional embodiments any number of zones, radio access networks, and client handsets may be supported.

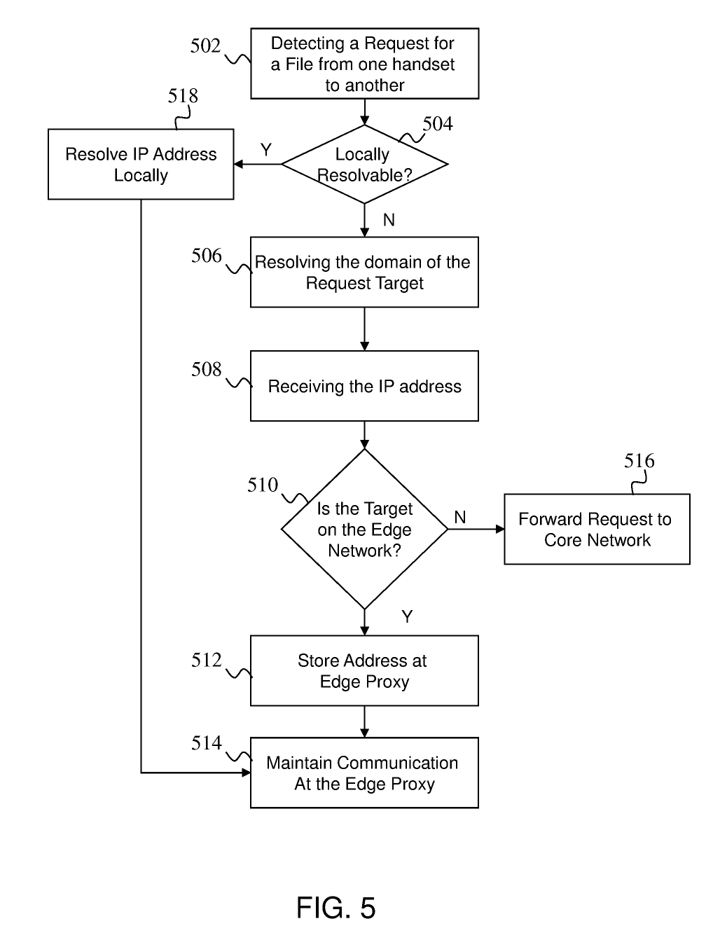

FIG. 5 depicts a flow diagram of the processing of a request for a file transfer from one client handset to a second client handset in an embodiment. In an embodiment, the process flow of FIG. 5 is executed by a computer processor executing on an edge proxy server which is in turn executing on a radio access network such as the radio access network 112 of FIG. 1. At block 502, a request from a first client handset is received at a radio access network. In an embodiment, the request includes a domain name of the target of the file request. At block 504, it is determined if the domain name of the target of the file request is locally resolvable by the radio access network. In an embodiment, the radio access network determines if the host name of the target is locally resolvable by looking up the host name in its resource directory, such as the resource directory 110 of FIG. 1. If the host name is locally resolvable, then processing continues at block 518. At block 518, the host name is resolved by finding the IP address of the host system in the resource directory. At block 514, the communication between the first client handset and the target of the file request is maintained by the edge proxy server without accessing the core network.

Returning to block 504, if the host name is not locally resolvable then processing continues at block 506. At block 506, the host name of the target is resolved using conventional methods, (i.e., a request for resolution of the host name by a DNS process). At block 508, the IP address is received as a result of the resolution operation. At block 510, it is determined if the IP address is the IP address of a client handset attached to the radio access network. If the client handset is in direct communication with the radio access network then the address is stored in the resource directory of the edge proxy server executing on the radio access network at block 512. A client handset is in direct communication if it is connected to the network via a wireless or wired connection to the radio access network. At block 514, the communication between the first client handset and the target of the file request is maintained by the edge proxy server without accessing the core network. Returning to block 510, if the IP address is not associated with a client handset in direct communication with the radio access network, then at block 516 the request is forwarded to the core network so that it can be processed by a client system on the network.

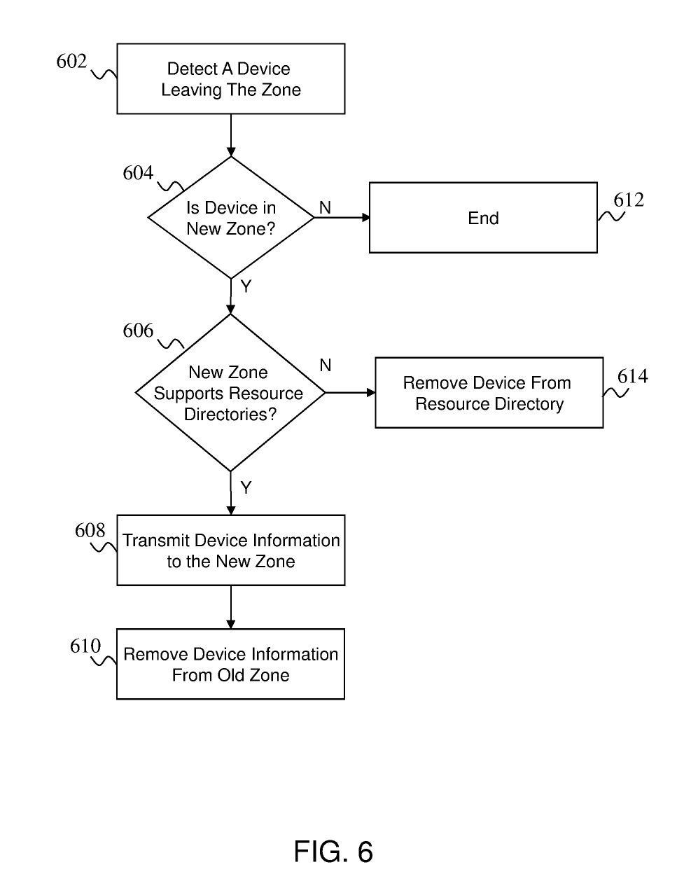

FIG. 6 depicts a flow diagram of the handling of the transfer of a client handset from a first zone to a second zone in an embodiment. In an embodiment the process flow of FIG. 6 is executed by an edge proxy server executing on a radio access network such as the radio access network 112 of FIG. 1. At block 602, the radio access network detects that a client handset is transferring out of its zone to a second zone. At block 604, it is determined if the client handset has successfully moved to the new zone. If the move was not successful, i.e., the client handset dropped from the network, processing ends at block 612.

Otherwise, if the transfer was successful, at block 606 it is determined if the new zone includes a resource directory. If the new zone includes a resource directory, then at block 608, the radio access network transmits the client handset's resolution information from the zone one resource directory to the new zone. The new zone then stores the resolution information in its resource directory and begins processing resolution requests locally for the client handset. At block 610, the resolution information from the client handset that was moved to the new zone is removed from the resource directory of the first zone. Returning to block 606, if the new zone does not support a resource directory, then the resolution information is removed from the resource directory of the first zone.

Technical effects and benefits include the ability to offload traffic from the core network for all file requests for files on other locally connected handsets. Another benefit is the ability to offload subsequent domain name resolution requests from the core network after the host name is initially resolved by the core network. Yet another benefit is the ability to transfer domain name resolution information from one zone to another zone as the handset moves from one zone to another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible storage medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or schematic diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In embodiments, the invention is embodied in computer program code executed by one or more network elements. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method for redirecting file traffic from a core server to a network edge, the method comprising:
receiving, by a computer, a request from one or more requestors in direct communication with the computer, for a file from a target system, the request comprising a host name of the target system;
determining, by the computer, if the host name is locally resolvable;
requesting, by the computer, a resolution of the host name from a domain name resolution process external to the computer, the requesting responsive to determining that the host name can not be locally resolved;
receiving an Internet protocol (IP) address of the target system, the IP address received from the domain name resolution process; and
routing all subsequent file requests by any of the one or more requestors for files from the target system directly to the target system without accessing a core network.

2. The computer implemented method of claim 1, wherein the IP address is stored locally responsive to determining that the target system is in direct communication with the computer.

3. The computer implemented method of claim 2, wherein the IP address is stored along with the host name in a resource directory, the resource directory locally accessible by the computer.

4. The computer implemented method of claim 3, wherein the routing occurs responsive to resolving the host name locally using the IP address and the host name stored in the resource directory.

5. The computer implemented method of claim 3, wherein the computer is located in a first zone, and the IP address and host name stored in the resource directory are transferred to a computer in a new zone responsive to determining that the target system has moved from the first zone to the new zone.

6. The computer implemented method of claim 3, wherein the computer is located in a first zone, and the IP address and the host name stored in the resource directory is removed from the resource directory responsive to determining that the target system has moved from the first zone to a new zone.

7. The computer implemented method of claim 1, wherein the one or more requestors and the target system are mobile handsets.

8. A system for redirecting file traffic from a core server to a network edge, the system comprising:
an edge proxy computer configured to perform:
receiving a request from one or more requestors in direct communication with the edge proxy computer, for a file from a target system, the request comprising a host name of the target system;
determining if the host name is locally resolvable;
requesting a resolution of the host name from a domain name resolution process external to the edge proxy computer, the requesting responsive to determining that the host name can not be locally resolved;
receiving an Internet protocol (IP) address of the target system, the IP address received from the domain name resolution process; and
routing all subsequent file requests by any of the one or more requestors for files from the target system directly to the target system without accessing a core network.

9. The system of claim 8, wherein the IP address is stored locally responsive to determining that the target system is in direct communication with the edge proxy computer.

10. The system of claim 9, wherein the IP address is stored along with the host name in a resource directory, the resource directory locally accessible by the edge proxy computer.

11. The system of claim 10, wherein the routing occurs responsive to resolving the host name locally using the IP address and the host name stored in the resource directory.

12. The system of claim 10, wherein the edge proxy computer is located in a first zone, and the IP address and host name stored in the resource directory are transferred to an edge proxy computer in a new zone responsive to determining that the target system has moved from the first zone to the new zone.

13. The system of claim 10, wherein the edge proxy computer is located in a first zone, and the IP address and the host name stored in the resource directory is removed from the resource directory responsive to determining that the target system has moved from the first zone to a new zone.

14. The system of claim 8, wherein the one or more requestors and the target system are mobile handsets.

15. A computer program product for redirecting file traffic from a core server to a network edge, the computer program product comprising:
a tangible storage medium readable by a processing circuit and storing instructions for execution by the processing circuit for performing a method comprising:
receiving a request from one or more requestors in direct communication with an edge proxy server, for a file from a target system, the request comprising a host name of the target system;
determining if the host name is locally resolvable;
requesting a resolution of the host name from a domain name resolution process external to the edge proxy server, the requesting responsive to determining that the host name can not be locally resolved;
receiving an Internet protocol (IP) address of the target system, the IP address received from the domain name resolution process; and
routing all subsequent file requests by any of the one or more requestors for files from the target system directly to the target system without accessing a core network.

16. The computer program product of claim 15, wherein the IP address is stored locally responsive to determining that the target system is in direct communication with the edge proxy server.

17. The computer program product of claim 16, wherein the IP address is stored along with the host name in a resource directory, the resource directory locally accessible by the edge proxy server.

18. The computer program product of claim 17, wherein the routing occurs responsive to resolving the host name locally using the IP address and the host name stored in the resource directory.

19. The computer program product of claim 17, wherein the edge proxy server is located in a first zone, and the IP address and host name stored in the resource directory are transferred to an edge proxy server in a new zone responsive to determining that the target system has moved from the first zone to the new zone.

20. The computer program product of claim 17, wherein the edge proxy server is located in a first zone, and the IP address and the host name stored in the resource directory is removed from the resource directory responsive to determining that the target system has moved from the first zone to a new zone.
